(19) United States
(12) Patent Application Publication
(10) Pub. No.: US 2018/0275026 A1
(43) Pub. Date: Sep. 27, 2018

(54) PLASTIC REFERENCE MATERIAL AND MANUFACTURING METHOD THEREOF

(71) Applicant: HITACHI HIGH-TECH SCIENCE CORPORATION, Tokyo (JP)

(72) Inventors: Yoshihiro HIRANO, Tokyo (JP); Kenji NAMIKI, Tokyo (JP); Noriaki SAKAI, Tokyo (JP); Hideyuki AKIYAMA, Tokyo (JP)

(21) Appl. No.: 15/928,327

(22) Filed: Mar. 22, 2018

(30) Foreign Application Priority Data
Mar. 24, 2017 (JP) 2017-058971

(51) Int. Cl. G01N 1/28; C08J 3/20

(52) U.S. Cl. CPC G01N 1/286; C08J 3/203; G01N 2030/025; G01N 2001/2873; C08J 2355/02

(57) ABSTRACT

Disclosed is to provide a plastic reference material and a manufacturing method thereof. The plastic reference material made by dispersing at least one chemical substance in a plastic substrate, and used for analyzing a concentration of the chemical substance, wherein the plastic reference material is of a granular shape and includes an average value for each maximum diameter of fifty or more of the plastic reference materials being within a range of 0.1 mm to 1.0 mm, and a largest difference between the maximum diameters and the average value being equal to or less than 0.2 mm, and an average value of each weight of equal to or more than fifty plastic reference materials being within a range of 0.1 mg to 0.5 mg, and a largest difference between the weights and the average value being equal to or less than 0.1 mg.

### CROSS REFERENCE TO RELATED APPLICATION

This application claims the benefit of Japanese Patent Application No. 2017-058971, filed Mar. 24, 2017, which is hereby incorporated by reference in its entirety into this application.

### BACKGROUND OF THE INVENTION

### 1. Technical Field

The present invention relates generally to a reference material used for analyzing chemical substances contained in a sample and to a manufacturing method thereof.

### 2. Description of the Related Art

Methods for analyzing chemical substances contained in a sample are roughly divided into an absolute analysis method that does not require a reference material, and a relative analysis method that performs quantitation by comparison with reference materials. As the reference material used in the relative analysis method, there may be a case where the pure substance of the analyte itself is used, but in order to reduce the analysis error due to the property of the sample, it is preferable to use a reference material having the same composition as the analytical sample.

Therefore, various analytical reference materials have been developed and are commercially available. Among these commercially available plastic reference materials, there are chips having a particle size of 1 mm to 2 mm cut out after extrusion molding, and chips having a size of 0.5 mm to 1 mm by crushing.

In addition, a reference material is also referred to as a standard sample.

As a method for directly analyzing chemical substances contained in plastic materials, pyrolysis gas chromatography (pyrolysis GC), pyrolysis-gas chromatography-mass spectrometry (pyrolysis GC/MS), and the like have been used. In these analysis methods, the components contained therein are evaporated by heating the solid sample, and the evaporated components are analyzed by a GC or a GC/MS instrument.

At this time, when an amount of the sample to be put into the instrument is too large, a large amount of plastic which is a main component of the sample, evaporates and interferes with the measurement of the desired chemical substance. Therefore, the amount of the sample (plastic material) is required to be equal to or less than 0.5 mg.

Therefore, a reference materials capable of taking a small amount of the sample have been proposed. For example, a technique has been described in which a compound containing red phosphorus is crushed to make it finer, a proportion of particles having a maximum diameter of 5 μm or more is reduced, and 0.1 mg to 0.5 mg of the crushed product is weighed to prepare a standard sample (Patent Document 1). In addition, a technique has been described in which a reference sample sheet in which a desired analysis component is dispersed in a plastic substrate is wound, and the sheet is punched at a predetermined size before analysis (Patent Document 2).

### Documents of Related Art

### (Patent Document 1) Japanese Patent No. 4770968

### (Patent Document 2) Japanese Patent Application Publication No. 2016-75649

### SUMMARY OF THE INVENTION

However, in case of the Patent Document 1, since particles (weight) of each reference material is smaller than amount of a sample required for putting into the analyzer, a plurality of particles is required to be weighed before analysis whereby the operation becomes complicated.

In addition, in case of the technique described in Patent Document 2, a punching operation is required before analysis.

Accordingly, the present invention has been made keeping in mind the above problems occurring in the related art, and an object of the present invention is to provide a plastic reference material and a manufacturing method thereof, the plastic reference material being capable of realizing an amount of a required sample as one particle or as several particles, with small variation in size/weight per particle, whereby an analysis can be easily and precisely performed.

In order to accomplish the above object, the present invention provides a plastic reference material made by dispersing at least one chemical substance in a plastic substrate, and used for analyzing a concentration of the chemical substance, wherein the plastic reference material is of granular shape; an average value (Dav) of individual maximum diameters (Dmax) of fifty or more of the plastic reference material is between 0.1 mm and 1.0 mm; a largest difference (Dv) between an individual maximum diameter (Dmax) of the plastic reference material and the average value (Dav) is equal to or less than 0.2 mm; an average value (Wav) of individual weights (W) of fifty or more of the plastic reference material is between 0.1 mg and 0.5 mg; and a largest difference (Wv) between an individual weight (W) of the plastic reference material and the average value (Wav) is equal to or less than 0.1 mg.

The plastic reference material makes possible to realize amount of a required sample as one particle or as several particles, with small variation in size/weight per particle, whereby analysis can be easily and precisely performed.

The plastic reference material further includes information with respect to deviation of the concentration of the chemical substance contained in one particle of the plastic reference materials.

The present invention provides a method of manufacturing a plastic reference material, including forming a compound by dispersing at least one chemical substance uniformly in a plastic substrate and pelletizing the compound in a liquid after melting the compound,

wherein, in pelletizing the compound, adjustment is made so that: an average value (Dav) of individual maximum diameters (Dmax) of fifty or more of the plastic reference material is between 0.1 mm and 1.0 mm; a largest difference (Dv) between an individual maximum diameter (Dmax) of the plastic reference material and the average value (Dav) is equal to or less than 0.2 mm; an average value (Wav) of individual weights (W) of fifty or more of the plastic reference material is between 0.1 mg and 0.5 mg; and a largest difference (Wv) between an individual weight (W) of the plastic reference material and the average value (Wav) is equal to or less than 0.1 mg.

According to the present invention, a plastic reference material is obtained, the plastic reference material being capable of realizing amount of a required sample as one particle or as several particles, with small variation in size/weight per particle, whereby analysis can be easily and precisely performed.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic cross-sectional view showing a plastic reference material according to an embodiment of the present invention;

FIG. 2 is a photograph showing appearances of pellets (plastic reference materials) of an embodiment;

FIG. 3 is a schematic view showing where a plastic reference material is put in a sample cup made of metal as a sample during a pyrolytic analysis;

FIG. 4 is a schematic view showing pelletizing process manufacturing a plastic reference material according to an embodiment of the present invention;

FIG. 5 is a photograph showing appearances of chips (plastic reference materials) of Comparative Example;

FIG. 6 is a graph showing a relation between maximum diameter Dmax of a pellet (plastic reference material) of Example and frequency;

FIG. 7 is a graph showing a relation between weight W of pellet (plastic reference material) of Example and frequency;

FIG. 8 is a graph showing a relation between weight of one pellet of Example and signal intensity of mass-to-charge ratio with respect to DIBP;

FIG. 9 is a graph showing a relation between maximum diameter Dmax of chip (plastic reference material) of Comparative Example and frequency;

FIG. 10 is a graph showing a relation between weight W of chip (plastic reference material) of Comparative Example and frequency; and

FIG. 11 is an exemplary diagram showing information on deviation of a concentration of a chemical substance per particle.

### DESCRIPTION OF THE PREFERRED EMBODIMENTS

Hereinafter, the exemplary embodiment of the present invention will be described with reference to the accompanying drawings.

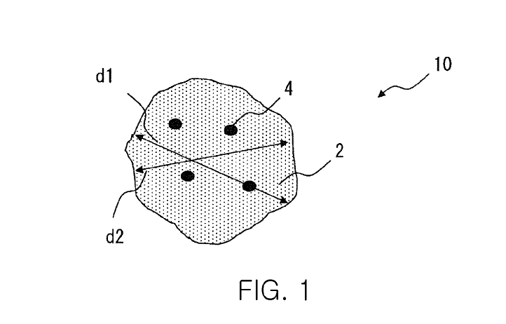

As shown in FIG. 1, a plastic reference material 10 is formed into a granular shape and made by dispersing at least one chemical substance 4 in a plastic substrate 2 which will be a matrix, whereby the plastic reference material 10 is used for analyzing the chemical substance.

The plastic substrate 2 is a polymer material having plasticity, for example, may be selected from acrylonitrile-butadiene-styrene copolymer resin (ABS resin), polyethylene, polypropylene, polycarbonate, polyvinyl chloride, polystyrene, polyester, polyethylene terephthalate, epoxy resin, acrylic resin, and polyurethane.

The chemical substance 4 which is a substance to be analyzed is not limited and may be selected from a metal, an organic compound, and an inorganic compound. As examples of metal and inorganic compounds, there are lead nitrate, cadmium nitrate, chromium nitrate, mercury sulfide, mercury, and red phosphorus. As examples of organic compounds, there are di-2-ethylhexyl phthalate, benzyl butyl phthalate, dibutyl phthalate, diisobutyl phthalate, di-n-octyl phthalate, diisononyl phthalate, diisodecyl phthalate, and decabromodiphenyl ether.

In addition, it is not necessary that the chemical substance 4 is one component and a plurality of chemical substances may be used for the chemical substance 4.

Furthermore, the chemical substance 4 may be dissolved in the plastic substrate 2 but not necessarily.

Here, according to ISO GUIDE 30: [Reference materials-Selected terms and definitions], a reference material is defined as “material, sufficiently homogeneous and stable with respect to one or more specified properties, which has been established to be fit for its intended use in a measurement process.”

Therefore, at least a concentration (per weight of the plastic reference material) of a chemical substance contained in the plastic reference material according to an embodiment of the present invention is measured and determined. In addition, the concentration per weight of described pellet with will be described below, but it is not limited thereto. For example, concentration per volume may be used also.

The plastic reference material of the present invention includes an average value Dav of individual maximum diameters Dmax of fifty or more of the plastic reference materials being within a range of 0.1 mm to 1.0 mm, and a largest difference Dv between the maximum diameters Dmax and the average value Dav being equal to or less than 0.2 mm. In addition, the plastic reference material of the present invention includes an average value Wav of individual weights W of fifty or more of the plastic reference materials being within a range of 0.1 mg to 0.5 mg, and a largest difference Wv between the weights W and the average value Wav being equal to or less than 0.1 mg.

As shown in FIG. 1, the maximum diameter Dmax is a maximum value when each diameter (d1, d2, . . . ) of plastic reference materials 10 is measured in every direction.

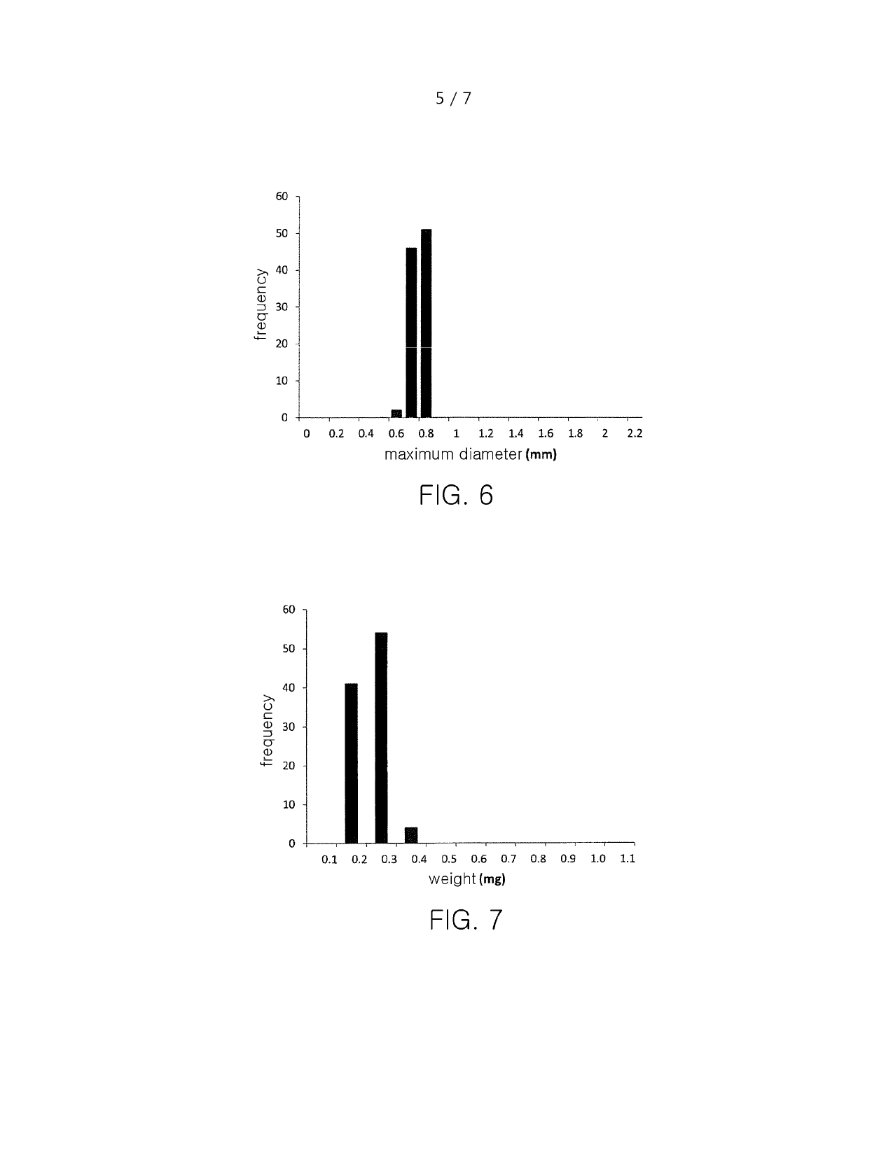

FIG. 6 shows a relation between the maximum diameter Dmax of one hundred plastic reference materials 10 of a following Example and frequency.

As shown in FIG. 6, the maximum diameter Dmax was distributed in a narrow range of 0.6 mm to 0.8 mm, and an average value Dav was 0.71 mm. In addition, a maximum value of the maximum diameter Dmax was 0.79 mm, a minimum value of the maximum diameter Dmax was 0.60 mm, and a largest difference Dv between the average diameter Dav and the maximum diameters Dmax was 0.11 mm (0.71 mm−0.60 mm).

At this point, if it is assumed that each particle of the plastic reference material 10 is a sphere having a diameter of 0.71 mm which is the average value Dav, a volume thereof is about 0.19 mm³. A density of the plastic reference material 10 is almost equal to a density of the plastic substrate 2 which becomes the matrix, and in the embodiment, it is assumed that the density of the plastic reference material 10 is equal to a density of ABS resin, 1.04 g/cm³, so a weight of the plastic reference material 10 is about 0.19 mg by calculation.

The calculated value is almost equal to 0.22 mg (refer to Table 2), which is a real average value Wav of the weight W and will be described hereafter. Therefore, it can be known that the pellet (plastic reference material 10) is close to a spherical shape.

Here, the average value Dav of the maximum diameter, the difference Dv of the maximum diameter, the average value Wav of the weight, the difference Wv of the weight are defined as the above ranges such that each plastic reference material 10 is close to a spherical shape and effects described hereinbelow are produced.

First, as the shape of the plastic reference material 10 becomes close to a sphere, a deviation of each shape of the plastic reference materials 10 is reduced and the measurement accuracy is increased.

In addition, when the plastic reference material 10 as a sample is put in a sample cup 50, which is made of metal and the center CE thereof is configured to be recessed as shown in FIG. 3, and pyrolytic analysis (for example, pyrolysis-GC/MS) is performed, heat conduction differs according to a position of the plastic reference material 10 in the sample cup 50, thereby affecting measurement results. Therefore, when the plastic reference material 10 is close to a spherical shape, the plastic reference material 10 rolls toward the recessed portion of the center CE of the sample cup 50 wherever the plastic reference material 10 is put in the sample cup 50, so the position of the sample is not changed for each measurement. Meanwhile, when the sample has no specific shape or the sample is provided as fine particles as in Patent Document 1, the sample is disposed in the sample cup unevenly. Also, a punched sheet sample having a form as Patent Document 2 is easily disposed in the sample cup unevenly, so the measurement accuracy is decreased.

Meanwhile, when the average value Dav is less than 0.1 mm, each plastic reference material is too small (light) and a required quantity of the plastic reference material to be put in the analysis equipment increases (for example, ten plastic reference materials), whereby an analysis operation becomes complicated. In addition, a surface area per unit weight of the plastic reference material becomes too large, so chemical substance contained in the reference material is easily volatized through the surface area of the reference material during preservation while time goes, and thus the concentration of the chemical substance contained in the reference material is reduced such that the determination accuracy is decreased.

On the other hand, when the average value Dav exceeds 1.0 mm, each plastic reference material is too large (heavy) and even a single plastic reference material is too large (heavy) for a required amount of the plastic reference material to be put in the analysis equipment, so the plastic reference material needs to be divided, whereby an analysis operation becomes complicated.

Furthermore, when the difference Dv exceeds 0.2 mm, weights of the plastic reference materials 10 vary, and an amount of a plastic which is a main component of the reference material varies with each measurement such that measurement precision is decreased. In addition, the plastic reference material 10 may have an unspecific shape other than a spherical shape and heat conduction differs according to a position of the plastic reference material 10 in the sample cup, thereby affecting measurement results.

Each weight W of the plastic reference material may be, for example, measured by an analytical balance with about at least 0.01 mg readability.

FIG. 7 shows a relation between the weight W of one hundred plastic reference materials 10 of a following Example and frequency.

As shown in FIG. 7, the weight W was distributed in a narrow range of 0.1 mg to 0.4 mg, and an average value Wav was 0.22 mg. In addition, a maximum value of the weight W was 0.32 mg, a minimum value of the weight W was 0.12 mg, and a largest difference Wv between the average weight Wav and the weights W was 0.1 mg.

Meanwhile, when the average value Wav is less than 0.1 mg, each plastic reference material is too small (light) and a required quantity of the plastic reference material to be put in the analysis equipment increases (for example, ten plastic reference materials), whereby an analysis operation becomes complicated.

On the other hand, when the average value Wav exceeds 0.5 mg, each plastic reference material is too large (heavy) and a single plastic reference material is too large (heavy) for a required amount of the plastic reference material to be put in the analysis equipment, so the plastic reference material needs to be divided, whereby an analysis operation becomes complicated.

Furthermore, when the difference Wv exceeds 0.1 mg, weights of the plastic reference materials 10 vary, and an amount of a plastic which is a main component of the reference material varies with each measurement such that the measurement precision is decreased. In addition, the plastic reference material 10 may have an unspecific shape other than a spherical shape and heat conduction differs according to a position of the plastic reference material 10 in the sample cup, thereby affecting measurement results.

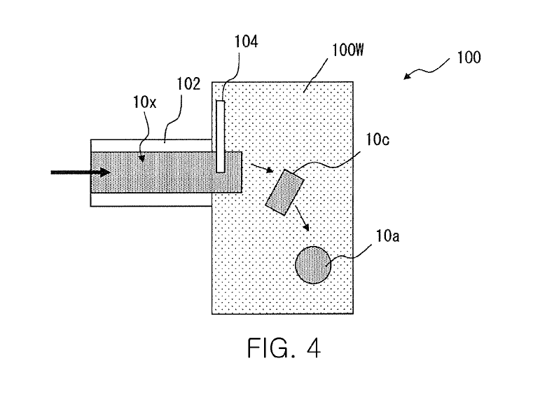

A manufacturing method of the plastic reference material according to an embodiment of the present invention will be described hereinbelow with reference to FIG. 4. The manufacturing method of the plastic reference material according to the embodiment includes forming a compound by dispersing at least one chemical substance uniformly in a plastic substrate, and pelletizing the compound in a liquid after melting the compound.

In the forming of the compound, at least one chemical substance needs to be dispersed uniformly in the plastic substrate, and well-known kneading methods may be used for the process. For example, materials are added and mixed in a kneader-extruder, a mixed compound is kneaded, extruded from the kneader-extruder into a water bath so as to form a strand shape of the compound, and cooled therein. Then, chips having a specific size (for example, about 3 mm of diameter and about 3 mm of length) are formed by cutting the compound using a strand cut method.

In addition, such process in which the obtained chips are put back into the kneader-extruder, kneaded, and formed as homogeneous chips may be repeated multiple times (for example, three times) to disperse the chemical substance contained in the compound uniformly. Furthermore, an initial compound extruded from the kneader-extruder may not be mixed enough, thus it is not preferable for use in manufacturing the plastic reference material.

A roll kneader may be used in the forming compound process.

In the pelletizing of the compound, the plastic reference material is manufactured by melting the compound and pelletizing the melted compound under water. As an example for a pelletizing method, there is an underwater cutting method using an underwater pelletizer 100 shown in FIG. 4 in which a melted compound 10x is extruded from a kneader-extruder 102, discharged to a water bath 100w, and then cut by a cutter 104. A melt 10c of the compound cut by the cutter 104 solidifies to form a smallest surface area thereby being a substantially spherical shape in the water, and becomes a plastic pellet 10a. In the present invention, what is not yet measured as a reference material refers to a “plastic pellet”.

A diameter of the plastic pellet 10a may be adjusted mainly by changing an extrusion speed for discharging the melted compound 10x to the water bath 100w of the underwater pelletizer 100. The larger the extrusion speed, the larger the size of the pellet.

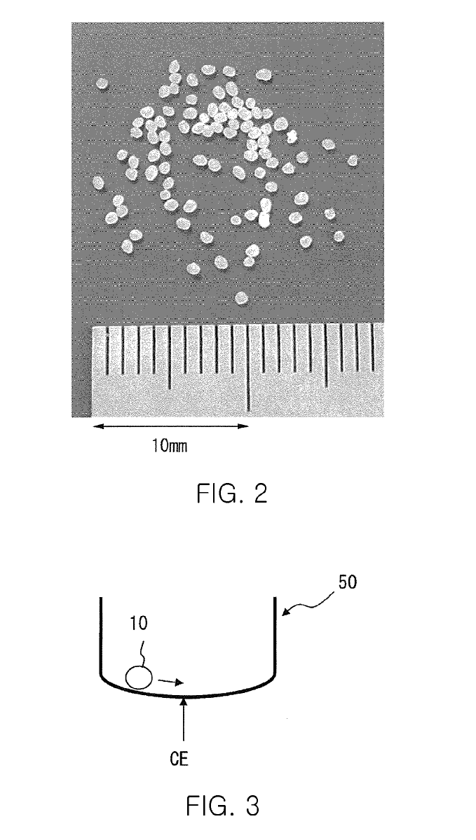

Since the plastic pellet 10a having the substantially spherical shape as shown in FIG. 2 is obtained as described above, parameters of the pelletizing (for example, the extrusion speed for the water bath 100w and the speed of the cutter 104) are adjusted to form that the average value Dav of each maximum diameter Dmax of equal to or more than fifty plastic pellets is in a range of 0.1 mm to 1.0 mm, the largest difference Dv between the maximum diameters Dmax and the average value Dav is equal to or less than 0.2 mm, the average value Wav for each weight W of equal to or more than fifty plastic pellets is 0.1 mg to 0.5 mg, and the largest difference Wv between the weights W and the average value Wav is equal to or less than 0.1 mg.

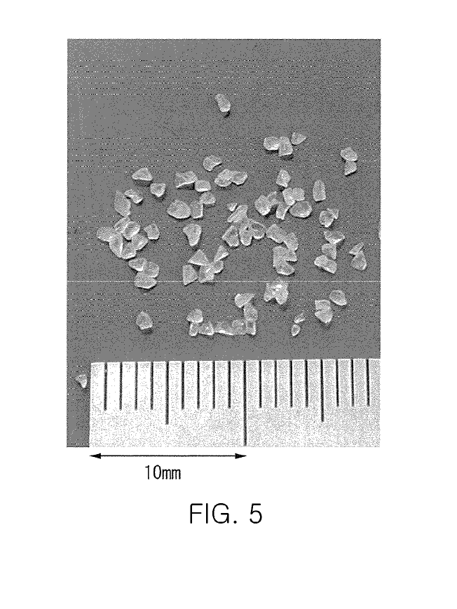

Meanwhile, FIG. 5 is a photograph showing appearances of chips formed by simply crashing the compound in the pelletizing process. When the compound is crashed, chips are formed as a polyhedral shape having corners not as a spherical shape.

According to the plastic reference material of the embodiment of the present invention as described above, the amount of the sample required to be put into the analyzer is realized as one particle or as several particles with small variation in weight per particle. In addition, it is possible to perform the analysis operation with ease and accuracy.

Furthermore, it is preferable to provide information with respect to the deviation of the concentration of the chemical substance contained in each of the plastic reference materials. The deviation does not represent concentration of chemical substances, but represents the variation of the concentration between particles.

Here, the plastic reference material of the embodiment realizes the amount of the sample required for the analysis by one particle or several particles (plastic reference material or the preceding pellet) as described above. However, if information on the deviation of the concentration of the chemical substance per particle is known, for example, the uncertainty component of the measurement value caused by the calibration curve formed by using the plastic reference material can be easily grasped.

For this reason, it is preferable to impart information on the deviation of the concentration of the chemical substance per particle to the plastic reference material. In addition, “deviation information” may be delivered from or displayed on a server when an electronic medium (such as a CD-ROM) or a serial number of a product is input on a web site, in addition to a form of a printout or a seal in a package of the plastic reference material product.

FIG. 11 is an exemplary diagram showing information (printed seal) on deviation of a concentration of a chemical substance per particle.

In addition, “deviation information” is not limited to standard deviation, relative standard deviation, or uncertainty of the concentration of the chemical substance per particle, but may be a physical quantity correlated with the concentration (for example, standard deviation relative standard deviation, or uncertainty, etc of signal intensity when measured with GC-MS instrument).

The present invention is not limited to above embodiments, and also various modifications, additions and substitutions are possible, without departing from the scope and spirit of the invention.

### Example 1

(Forming Compound)

To form a compound, acrylonitrile-butadiene styrene copolymer resin (ABS resin) was used as the plastic substrate, and diisobutyl phthalate (DIBP) was used as a chemical substance. First, about 1.5 kg of ABS resin pellet was put in a plastic bag, and about 1.6 g of DIBP was added and mixed. The obtained mixture was kneaded with a kneader-extruder, and thus a strand-shaped compound was extruded from a kneader-extruder into a water bath. Then chips of a predetermined size (diameter of about 3 mm and length of about 3 mm) were formed by a strand cutting method in which cutting was performed.

The process in which obtained chips were put back into the kneader-extruder, kneaded, and formed as homogeneous chips was repeated three times. In addition, an initial compound extruded from the kneader-extruder may not be mixed enough, so the initial compound was discarded. The chip-shaped compound finally obtained was about 1 kg.

(Pelletizing)

The obtained chip-shaped compound was put into an underwater pelletizer 100 shown in FIG. 4, and thus pellets having a diameter of about 0.7 mm were manufactured by an underwater cutting method. The finally obtained pellets were about 40 g.

For comparison, the above described compound was crashed in the pelletizing process to manufacture chips for a comparative embodiment.

(Measuring a Concentration of DIBP in the Pellet to Make a Reference Material)

The concentration (per weight of pellet) of DIBP in the pellet obtained in Example was quantified by solvent extraction GC/MS method. In specific, about 500 mg of pellets was precisely weighed and collected, and DIBP in the pellets was extracted into an organic solvent. The obtained solution of DIBP was analyzed by GC/MS instrument using a calibration curve of DIBP standard solution. As a result, the concentration in the pellet was calculated to be 966 mg/kg.

(Measuring a Deviation of the Concentration/Signal Intensity Per Particle of the Plastic Reference Material)

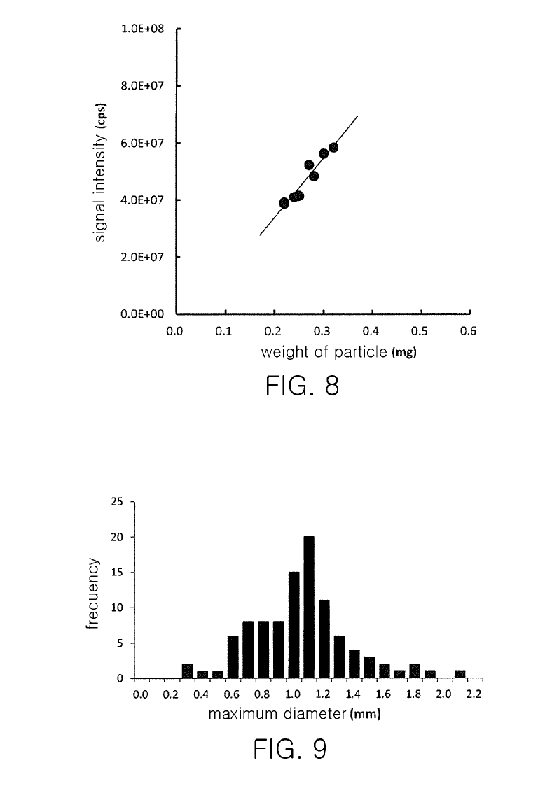

Table 1 and FIG. 8 show a relation between the weight of one particle and the signal intensity of mass-to-charge ratio with respect to DIBP when analyzing each particle by pyrolysis-GC/MS, for eight plastic reference materials. In addition, a straight line in FIG. 8 is a regression line according to the least squares method of eight plots, and it can be seen that there is a good linear relation between the weight of the particle and the signal intensity.

Here, since the signal intensity is proportional to the weight of DIBP contained in one particle of the plastic reference material, a deviation of the concentration per one particle can be estimated from the deviation of the signal intensity per unit weight which is divided by the weight of one pellet.

Table 1 shows that results of signal intensity per unit weight in this manner. For eight particles, a relative standard deviation representing the deviation of the signal intensity is 5.1%. The value is an estimate value of the deviation of the concentration per one particle, that is, “deviation information” of the concentration.

TABLE 1

| | Weight of | Signal | Signal intensity |
|---|---|---|---|
| Particle | particle | intensity | per unit weight |
| No. | (mg) | (cps) | (cps/mg) |
| 1 | 0.27 | 5.23E+07 | 1.94E+08 |
| 2 | 0.22 | 3.88E+07 | 1.76E+08 |
| 3 | 0.22 | 3.92E+07 | 1.78E+08 |
| 4 | 0.24 | 4.11E+07 | 1.71E+08 |
| 5 | 0.25 | 4.15E+07 | 1.66E+08 |
| 6 | 0.32 | 5.85E+07 | 1.83E+08 |
| 7 | 0.28 | 4.85E+07 | 1.73E+08 |
| 8 | 0.30 | 5.64E+07 | 1.88E+08 |

| | |
|---|---|
| Average | 1.79E+08 |
| Relative standard deviation | 5.1% |

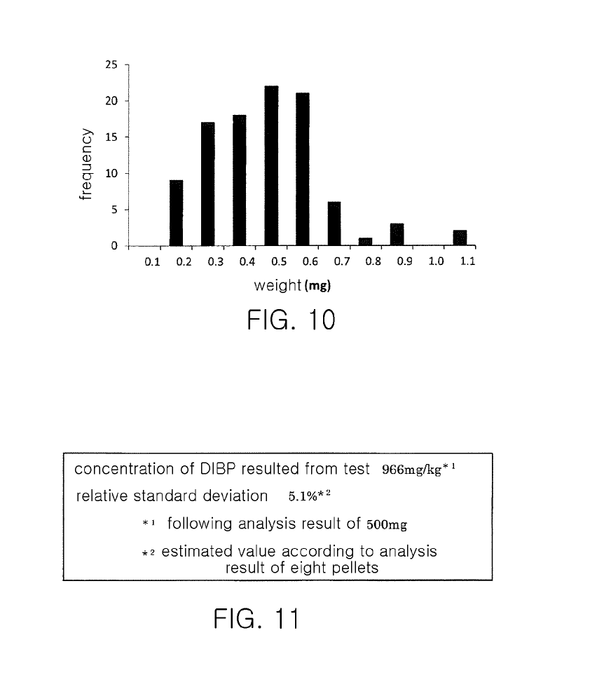

FIG. 6 shows a relation between maximum diameter Dmax of the pellet of Example and frequency, and FIG. 7 shows a relation between weight W of the pellet of Example and frequency. Likewise, FIG. 9 shows a relation between maximum diameter Dmax of the pellet of Comparative Example and frequency, and FIG. 10 shows a relation between weight W of the pellet of Comparative Example and frequency.

In addition, Table 2 shows summarizing results thereof.

TABLE 2

| | Dmax(mm) | Dav(mm) | Dv(mm) | W(mg) | Wav(mg) | Wv(mg) |
|---|---|---|---|---|---|---|
| Example | 0.60-0.79 | 0.71 | 0.11 | 0.12-0.32 | 0.22 | 0.10 |
| Comparative | 0.30-2.05 | 1.02 | 1.03 | 0.14-1.03 | 0.43 | 0.60 |
| example | | | | | | |

As shown in Table 2, the average value Dav of the maximum diameter of Example was 0.71 mm. In addition, the maximum value of the maximum diameter Dmax was 0.79 mm, the minimum value of the maximum diameter Dmax was 0.60 mm, and the largest difference Dv between the average value Dav and the maximum diameters Dmax was 0.11 mm (0.71 mm−0.60 mm).

In addition, the average weight value Wav of the pellet of Example was 0.22 mg. The maximum value of the weight W was 0.32 mg, the minimum value of the weight W was 0.12 mg, and the largest difference Wv between the average weight Wav and the weights W was 0.10 mg.

At this point, if it is assumed that the pellet of Example is a sphere having a diameter of 0.71 mm which is the average value Dav, a volume thereof is about 0.19 mm³. It s assumed that a density of the pellet is equal to a density of ABS resin which becomes the matrix, 1.04 g/cm³, so a weight of the pellet is about 0.19 mg by calculation. The calculated value is almost equal to Wav=0.22 mg, therefore, it can be known that the pellet of Example is close to a spherical shape.

Meanwhile, an average value Dav of the maximum diameter of the chip of Comparative Example was 1.02 mm. In addition, a maximum value of the maximum diameter Dmax was 2.05 mm, a minimum value of the maximum diameter Dmax was 0.30 mm, and a largest difference Dv between the average value Dav and the maximum diameters Dmax was 1.03 mm (2.05 mm−1.02 mm).

In addition, a maximum value of the weight W of the chip of Comparative Example was 1.03 mg, a minimum value of the weight W of the chip of Comparative Example was 0.14 mg, and a largest difference Wv between an average weight value Wav and the weights W was 0.60 mg.

As described above, at least one among Dav, Dv, Wav, and Wv (specifically, Dv and Wv) of the chip of Comparative Example was out of a scope of the present invention.

In addition, it is assumed that the chip of Comparative Example is a sphere having a diameter of 1.02 mm which is the average value Dav, a volume thereof is about 0.56 mm³ and a weight of the chip is about 0.58 mg by calculation. The calculated value is far from Wav=0.43 mg, and it can be known that the chip of Comparative Example is non-spherical shape and also has not specific shape with reference to FIG. 5.

What is claimed is:

1. A plastic reference material made by dispersing at least one chemical substance in a plastic substrate, and used for analyzing a concentration of the chemical substance, wherein the plastic reference material is of granular shape;
an average value (Dav) of individual maximum diameters (Dmax) of fifty or more of the plastic reference material is between 0.1 mm and 1.0 mm;
a largest difference (Dv) between an individual maximum diameter (Dmax) of the plastic reference material and the average value (Dav) is equal to or less than 0.2 mm;
an average value (Wav) of individual weights (W) of fifty or more of the plastic reference material is between 0.1 mg and 0.5 mg; and
a largest difference (Wv) between an individual weight (W) of the plastic reference material and the average value (Wav) is equal to or less than 0.1 mg.

2. The plastic reference material of claim 1, wherein the plastic reference material comprises information with respect to a deviation of the concentration of the chemical substance contained in one particle of the plastic reference material.

3. A method of manufacturing a plastic reference material, comprising:
forming a compound by dispersing at least one chemical substance uniformly in a plastic substrate and
pelletizing the compound in a liquid after melting the compound,
wherein, in pelletizing the compound, adjustment is made so that:
an average value (Dav) of individual maximum diameters (Dmax) of fifty or more of the plastic reference material is between 0.1 mm and 1.0 mm;
a largest difference (Dv) between an individual maximum diameter (Dmax) of the plastic reference material and the average value (Dav) is equal to or less than 0.2 mm;
an average value (Wav) of individual weights (W) of fifty or more of the plastic reference material is between 0.1 mg and 0.5 mg; and
a largest difference (Wv) between an individual weight (W) of the plastic reference material and the average value (Wav) is equal to or less than 0.1 mg.
